(19) United States
(12) Patent Application Publication
(10) Pub. No.: US 2026/0057657 A1
(43) Pub. Date: Feb. 26, 2026

(54) MULTI-AZIMUTH FUSION FOR BIRD'S EYE VIEW BASED PERCEPTION

(71) Applicant: QUALCOMM Incorporated, San Diego, CA (US)

(72) Inventors: Venkatraman NARAYANAN, Northville, MI (US); Varun RAVI KUMAR, San Diego, CA (US); Senthil Kumar YOGAMANI, San Diego, CA (US)

(21) Appl. No.: 18/813,972

(22) Filed: Aug. 23, 2024

(51) Int. Cl. G06V 10/80; G06V 20/56; G06V 20/58

(52) U.S. Cl. CPC G06V 10/811; G06V 20/58; G06V 20/588

(57) ABSTRACT

Certain aspects of the present disclosure provide techniques for bird's eye view perception. A method for multi-azimuth bird's eye view perception by an apparatus comprising: obtaining first perception sensor data, generated by one or more sensors, corresponding to an environment of the apparatus; generating, based on the first perception sensor data, a first plurality of projections of the environment from multiple azimuth perspective angles; extracting a respective feature set from each of the first plurality of projections; fusing the respective feature set of each of the first plurality of projections into a multi-azimuth bird's eye view of the environment; and storing the multi-azimuth bird's eye view in one or more memories.

### INTRODUCTION

### Field of the Disclosure

Aspects of the present disclosure relate to bird's eye view (BEV) perception.

### DESCRIPTION OF RELATED ART

Apparatuses, such as robots, autonomous vehicles, or the like, include one or more sensors, such as one or more image sensors (e.g., cameras), light detection and ranging equipment, radio detection and ranging equipment, one or more SONAR sensors, or the like. The apparatuses may include autonomous driving perception systems that rely on fusion of data from one or more sensors. Fusion of data may include generating a bird's eye view (BEV) perception of an environment which may be subsequently utilized for advanced navigation tasks, such as autonomous driving tasks. BEV perception typically relies upon single viewpoint representations generated by transforming features from sensor data, such as camera and/or LiDAR features, to a viewpoint directly above the ego-apparatus (e.g., ego-vehicle) looking down into a BEV of the environment. Various transformation processes may be utilized to map features from sensor data into the BEV plane. For example, some transformation processes use pyramid occupancy networks, while others may use a Lift-Splat approach, a scanline-to-BEVline transformer, a deformable attention network, bilinear sampling, or other technique. However, since traditional methods of constructing BEV representations rely on single viewpoint representations, the traditional methods may be unable to successfully handle occlusions or capture small objects, such as road debris, cones, potholes, barriers or the like within the BEV representation.

Accordingly, there exists a need to develop a perception solution that can reliably represent occlusions and capture small objects in the environment.

### SUMMARY

One aspect provides a method for multi-azimuth bird's eye view perception by an apparatus. The method includes obtaining first perception sensor data, generated by one or more sensors, corresponding to an environment of the apparatus; generating, based on the first perception sensor data, a first plurality of projections of the environment from multiple azimuth perspective angles; extracting a respective feature set from each of the first plurality of projections; fusing the respective feature set of each of the first plurality of projections into a multi-azimuth bird's eye view of the environment; and storing the multi-azimuth bird's eye view in the one or more memories.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative environment of a road scene.

FIG. 2 depicts an illustrative sensor and computing system equipped apparatus, such as a vehicle.

FIG. 3 depicts an illustrative multi-azimuth fusion architecture.

FIG. 4A depicts illustrative projections of the environment from multiple azimuth perspective angles.

FIG. 4B depicts illustrative three-dimensional diagram corresponding to the multiple azimuth perspective angles for the projections illustrated in FIG. 4A.

FIG. 5 depicts a method for generating multi-modal multi-azimuth bird's eye view (BEV).

FIG. 6 depicts aspects of an example apparatus, such as a vehicle.

### DETAILED DESCRIPTION

Aspects of the present disclosure provide apparatuses, methods, processing systems, and computer-readable mediums for generating multi-azimuth bird's eye view (BEV). BEV perception may offer advantages such as intuitive representation of surrounding scenes and compatibility with fusion techniques. BEV perception may conventionally rely upon single viewpoint representations generated by transforming features from sensor data, such as camera and/or LiDAR features, to a viewpoint directly above the ego-apparatus (e.g., ego-vehicle) looking down into a BEV of the environment. Traditional methods of constructing BEV representations may be unable to successfully handle occlusions or capture small objects, such as road debris, cones, potholes, barriers or the like. For example, traditionally generated BEV representations may lose 3D information through view transformation from perspective view to the BEV.

Consequently, traditional BEV representations may be unable to completely or accurately handle representations that include occlusions, such as trees overhanging roads or bridges, which in turn pose challenges to self-driving vehicles or terrestrial robots when performing autonomous or semi-autonomous driving tasks or robot perception and navigation tasks, respectively. Additionally, the loss of 3D information also may make perception of small objects, such as potholes, debris, cones, barriers and the like complex or impossible to capture in single viewpoint BEV representations.

Aspects described herein may address these technical challenges by providing techniques for generating multi-azimuth BEV perception of an environment that includes BEV features from multiple different azimuth angles. In certain aspects, the BEV features represent aspects such as edges, surfaces, colors, textures, and the like of objects in the environment. BEV features from multiple different azimuth angles may enable the BEV to gain additional perspectives to overcome issues with perceiving occluded objects and small objects. In certain aspects, techniques disclosed herein integrate perception sensor data from one or more sensors, such as cameras, LiDAR or the like. The perception sensor data may be captured from various azimuth angles around the vehicle, thus producing BEV features from different azimuth angles. In certain aspects, the perception sensor data may be utilized to generate additional projections from multiple azimuth perception angles to gain additional perspectives, such as to overcome occlusion issues and generate further information regarding small objects present in the environment. In certain aspects, feature sets are extracted from the projections and fused together based on the extracted features to generate a multi-azimuth BEV perception of the environment.

In certain aspects, the perception sensor data may be generated from multiple different types of sensors. In certain such aspects, the perception sensor data (e.g., multi-modal perception sensor data) from each of the different sensors may be projected into multiple projections from the multiple azimuth perception angles. The feature sets extracted from the multiple projections may be fused together to generate a multi-modal multi-azimuth BEV perception of the environment.

In certain aspects, the multi-azimuth BEV perception and multi-modal multi-azimuth BEV perception of the environment generated by the techniques described herein may provide a more comprehensive and robust encoding of the environment as compared to traditional BEV perceptions.

Aspects will be described with reference to the drawings, where like structure is indicated with like reference numerals.

### BEV Perception of an Environment

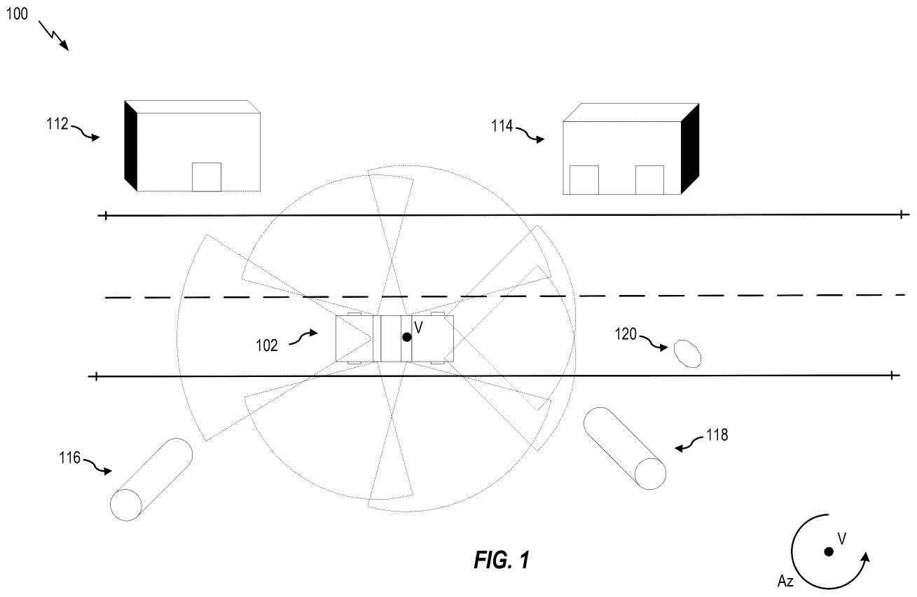

FIG. 1 depicts an illustrative environment 100 of a road scene. The road scene includes a vehicle 102 equipped with a plurality of sensors, optionally having different modalities, that are fused together following techniques described herein to generate a multi-azimuth BEV perception or a multi-modal multi-azimuth BEV perception of the environment. In certain aspects (not shown), the vehicle 102 may be equipped with one or more of the same type of sensor and different projections from the same one or more sensors may be fused together following techniques described herein to generate a multi-azimuth BEV perception of the environment. The multi-azimuth BEV perception, which may be single or multi-modal, of the environment include features such as structures 112, 114, signs or poles 116, 118, potholes 120, and/or other features not specifically depicted in FIG. 1. The plurality of sensors may each have a corresponding field of view illustratively depicted by the dashed lined fields.

Certain aspects described herein may utilize not only the view point of the sensor with reference to their field of view to search for features, but also adjust the azimuth perspective angle of the sensor data to extract additional and richer feature information about the environment. For example, the nominal viewpoint of a camera defines its field of view. However, the image data captured by the camera can be viewed from different azimuth perspective angles, which are different from the nominal viewpoint of the camera in order to obtain different perspectives and potentially information about features, for example, contributing to small objects or occluded space. Certain aspects described herein provide techniques for combining multi-azimuth viewpoints of the sensor data to generate more feature rich and dense BEV planes corresponding to environments of the vehicle 102.

It should be understood that while the illustrative example discussed herein include a vehicle 102 traversing a road environment, the techniques described herein may be implemented on various apparatuses such as a robot operating in a facility or other environment. Additionally, in certain aspects, the techniques described herein may be implemented on one or more various apparatuses separate from apparatus configured with sensors to collect perception sensor data of the environment. For example, the vehicle 102 may be a terrestrial vehicle such as an automobile, a truck, a motorcycle, a bicycle, a robotic device, or the like; an amphibious vehicle, such as a boat, a sailboat, a ship, a submarine, an unmanned amphibious vehicle, or the like; or an aerial vehicle such as a helicopter, a quadcopter, an unmanned aerial vehicle or the like.

Given the road scene depicted in FIG. 1, specific aspects will be described herein.

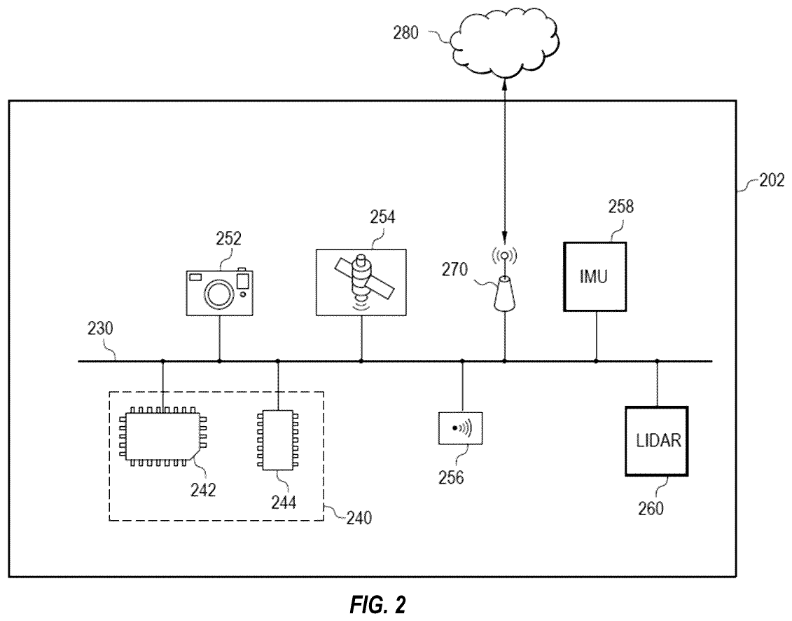

FIG. 2 depicts an illustrative sensor and computing system equipped apparatus, such as an autonomous vehicle (AV) corresponding to aspects described herein. The apparatus 202 may be an example of the vehicle 102 depicted in FIG. 1 or other apparatus such as a robot. The apparatus 202 depicted in FIG. 2 is depicted by way of an example schematic of a vehicle including sensor resources and a computing device. Not every vehicle is required to be equipped with the same set of sensor resources, nor is every vehicle required to be configured with the same set of systems for perceiving attributes of an environment. FIG. 2 only provides one example configuration of sensor resources and systems equipped within a vehicle.

In particular, FIG. 2 provides an example schematic of apparatus 202 including a variety of sensor resources, which may be utilized by the apparatus 202 to perceive and collect sensor data about the environment. For example, the apparatus 202 may include a computing device 240 comprising one or more processors 242 and a non-transitory computer readable memory 244 (also referred to herein as one or more memories), one or more cameras 252, a global positioning system (GPS) 254, a radar system 256, an IMU 258, a LIDAR system 260, and network interface hardware 270. The aforementioned components of the apparatus are merely exemplary as some apparatuses may have more or less components and/or different sensors for perceiving the environment. These and other components of the apparatus 202 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverses. Moreover, the communication path 230 may be formed from a combination of mediums capable of transmitting signals. In one embodiment, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and non-transitory computer readable memory, referred to herein as one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the apparatus 202 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise RAM, ROM, flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The apparatus 202 may further include one or more cameras 252. The one or more cameras 252 may be any device having an array of sensing devices (e.g., a CCD array or active pixel sensors) capable of detecting radiation in an ultraviolet wavelength band, a visible light wavelength band, or an infrared wavelength band. The one or more cameras 252 may have any resolution. The one or more cameras 252 may be an omni-direction camera or a panoramic camera. In some embodiments, one or more optical components, such as a mirror, fish-eye lens, or any other type of lens may be optically coupled to the one or more cameras 252. The image data collected by the one or more cameras 252 may be stored in the one or more memories 244.

Still referring to FIG. 2, a global positioning system, GPS 254, may be coupled to the communication path 230 and communicatively coupled to the computing device 240 of the apparatus 202. The GPS 254 is capable of generating location information indicative of a location of the apparatus 202 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 254 may be stored in the one or more memories 244.

The apparatus 202 may also include a radar system 256. The radar system 256 measures the distance to objects over wide distances. It is also possible to measure the relative speed of the detected object. The radar system 256 may be a continuous wave (CW), frequency-modulated continuous wave (FMCW), 3D-radar (3D FMCW multiple-input and multiple-output (MIMO)), or 4D-radar (4D FMCW MIMO). The sensor data collected by the radar system 256 may be stored in the one or more memories 244.

The apparatus 202 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

In some aspects, the apparatus 202 may include a LIDAR system 260. The LIDAR system 260 is communicatively coupled to the communication path 230 and the computing device 240. A LIDAR system 260 or light detection and ranging is a system and method of using pulsed laser light to measure distances from the LIDAR system 260 to objects that reflect the pulsed laser light. A LIDAR system 260 may be made as solid-state devices with few or no moving parts, including those configured as optical phased array devices where its prism-like operation permits a wide field-of-view without the weight and size complexities associated with a traditional rotating LIDAR system 260. The LIDAR system 260 is particularly suited to measuring time-of-flight, which in turn can be correlated to distance measurements with objects that are within a field-of-view of the LIDAR system 260. By calculating the difference in return time of the various wavelengths of the pulsed laser light emitted by the LIDAR system 260, a digital 3-D representation of a target or environment may be generated. The pulsed laser light emitted by the LIDAR system 260 includes emissions operated in or near the infrared range of the electromagnetic spectrum, for example, having emitted radiation of about 905 nanometers. Sensors such as the LIDAR system 260 can be used by vehicles to provide detailed 3D spatial information for the identification of objects near the apparatus 202, as well as the use of such information in the service of systems for vehicular mapping, navigation and autonomous operations, especially when used in conjunction with geo-referencing devices such as GPS 254 or a gyroscope-based inertial navigation unit (INU, not shown or IMU 258) or related dead-reckoning system. The point cloud data collected by the LIDAR system 260 may be stored in the one or more memories 244.

Still referring to FIG. 2, apparatuses, such as vehicles are now more commonly equipped with communication systems, such as vehicle-to-vehicle communication systems. Some of the systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another vehicle, such as equipped with a vehicle-to-vehicle communication system. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 270 includes hardware configured to operate in accordance with the Bluetooth wireless communication protocol. In another embodiment, network interface hardware 270 may include a Bluetooth send/receive module for sending and receiving Bluetooth communications to/from a network 280 and/or another vehicle.

### Aspects Related to Generating Multi-Azimuth BEV Perception

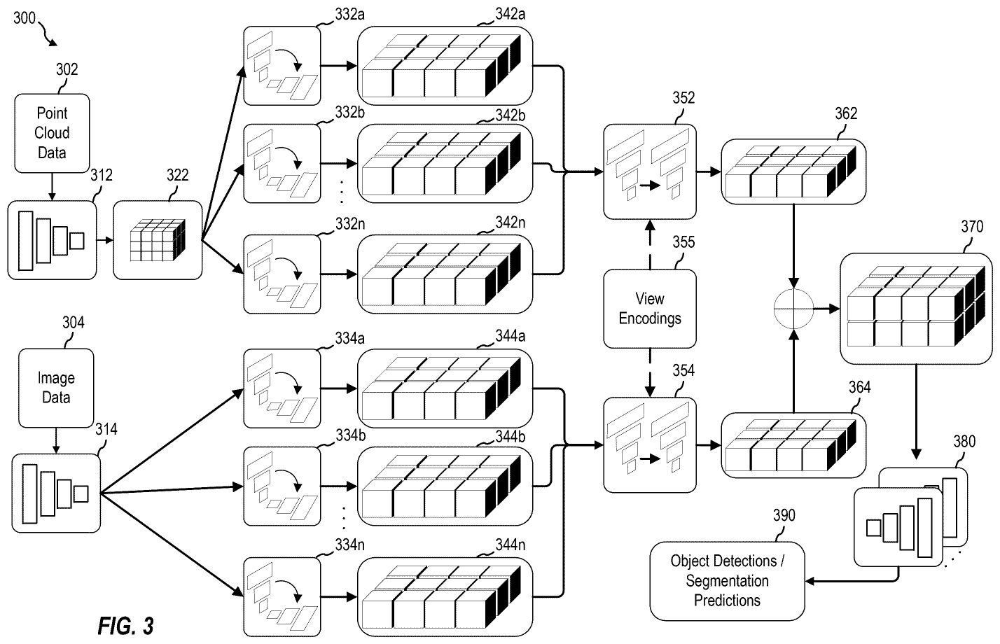

FIG. 3 depicts an illustrative multi-azimuth fusion architecture 300 for generating a multi-modal multi-azimuth BEV perception. The multi-azimuth fusion architecture 300 includes several components which will be described herein. The illustrative multi-azimuth fusion architecture 300 depicts a multi-modal architecture where first perception sensor data 302 of an environment, captured by a first set of one or more sensors, and second perception sensor data 304 of the environment, captured by a second set of one or more sensors, different from the first second of one or more sensors is processed by the architecture to generate a multi-modal multi-azimuth BEV of the environment. It is understood that this is just one example of the multi-azimuth fusion architecture 300. In some aspects, only one set of perception sensor data (e.g., either the first perception sensor data 302 or the second perception sensor data 304) is utilized. In some aspects, two or more sets of perception sensor data is utilized. The sets of perception sensor data may be generated by one or more modalities of sensors.

For example, the illustrative multi-azimuth fusion architecture 300 includes a first perception sensor data 302, which may be point cloud data captured by one or more LiDAR systems (e.g., the LiDAR system 260, FIG. 2), radar systems (e.g., the radar system 256, FIG. 2), or the like. The illustrative multi-azimuth fusion architecture 300 also includes a second perception sensor data 304, which may be image data captured by one or more cameras (e.g., the one or more cameras 252, FIG. 2).

In certain aspects, the multi-azimuth fusion architecture 300 includes distinct processes for different types of perception sensor data. Aspects of the multi-azimuth fusion architecture 300 described herein provide illustrative processes for handling point cloud data and image data, respectively.

For point cloud data, which is referred to herein as the first perception sensor data 302, the first perception sensor data 302 may be voxelized. Voxelization of point cloud data includes discretizing continuous data into 3D space which is divided into cubes. Each of the cubes is assigned a center point according to its neighboring points. A voxel is considered to be occupied when at least one point in the point cloud occupies the cube space defining the voxel. At block 312, the voxelized point cloud is fed through a 3D encoder backbone. The 3D encoder backbone is configured to extract features from the voxels to generate LiDAR 3D features 322 (e.g., a 3D feature volume). The 3D encoder backbone may be an autoencoder, wavelet scattering model, a deep neural network, or the like.

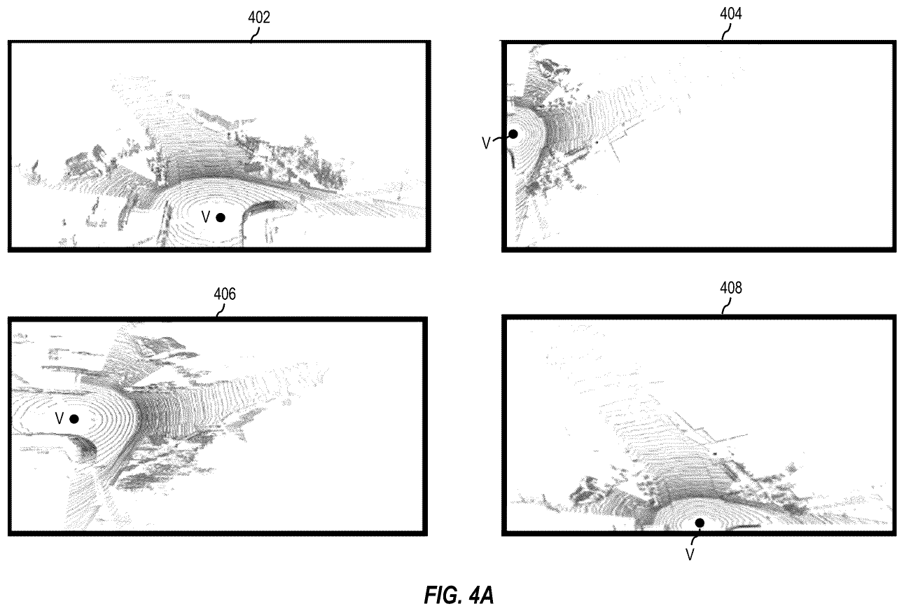

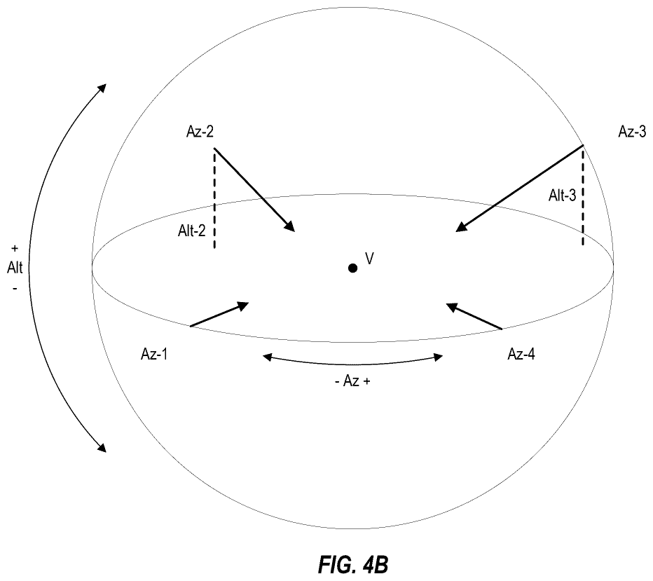

The LiDAR 3D features 322 are then sampled at multiple azimuth perspective angles to generate a plurality of projections of the LiDAR 3D features 322. The LiDAR 3D features 322 may be sampled from angles that cover the entire 3D grid scene, for example, 360 degrees about the 3D grid scene or may cover a portion of the 3D grid scene, for example, less than 360 degrees about the 3D grid scene. In certain aspects, sampling intervals of the multiple azimuth perspective angles may include equal angle intervals, for example, every degree or every couple of degrees. In certain aspects, the sampling intervals may be randomly generated, pre-defined for a specific task, or learned through a training process. The multiple azimuth perspective angles are viewpoints of the LiDAR 3D features 322 from various points on a horizon of the LiDAR 3D features 322. For example, FIG. 4A depicts illustrative projections 402, 404, 406, and 408 of the LIDAR 3D features 322 from multiple azimuth perspective angles. For example, sampling at multiple azimuth perspective angles includes defining one or more viewpoints from an azimuth perspective angle that is different from the perspective of the sensor configured to collect the perception sensor data. As illustrated in FIG. 4B, the perspective of the first perception sensor data is from point V, representing the viewpoint of the sensor configured to collect the perception sensor data. One or more additional perception angles Az-1, Az-2, Az-3, Az-4 may be defined to view the perception sensor data, for example, from viewpoint that is located away from the sensor equipped on the vehicle, point V, thereby creating an additional perspective view of the perception sensor data. The one or more additional perception angles Az-1, Az-2, Az-3, Az-4 are located at different positions about an azimuth “-Az+” with a reference to point V. In some aspects, the one or more additional perception angles, for example, perception angles Az-2 and Az-3 are defined by an azimuth angle and an angle above the ground (e.g., altitude Alt). For example, as depicted in FIG. 4B, perception angles Az-2 and Az-3 define a viewpoint that is also an altitude Alt-2 and Alt-3, respectively above the ground, which corresponds to the plane where point V exists. The altitude of the of the one or more additional perception angles Az-1, Az-2, Az-3, Az-4 may be above or below the altitude of the sensor configured to collect the perception data.

At blocks 332a, 332b to 332n, each of which corresponds to one of the multiple azimuth perspective angles, the extracted features that are viewed from the multiple azimuth perspective angles of the LiDAR 3D features 322 are projected onto a BEV plane. Since LiDAR directly provides 3D coordinates, depth estimation is not required for the projection. In certain aspects, the extracted 3D features comprise a 3D feature volume. The projection onto the BEV plane may be accomplished by implementing a vertical dimension reduction process to form a BEV representation of the 3D features surrounding the vehicle.

Blocks 332a, 332b to 332n form respective BEV projections of the LiDAR 3D features 322 corresponding to the multiple azimuth perspective angles around the vehicle, resulting in multi-azimuth LiDAR BEV features 342a, 342b to 342n. The multi-azimuth LIDAR BEV features 342a, 342b to 342n are fused at block 352 into a fused BEV LiDAR feature volume 362. The multi-azimuth LiDAR BEV features 342a, 342b to 342n may be fused into a fused BEV LIDAR feature volume 362 by a multi-azimuth fuser transformer (also referred to as a multi-azimuth view fuser). The multi-azimuth fuser transformer may be based on Vision Transformer (ViT), which is a model that employs a transformer-like architecture over patches of an image. For example, the image may be split into fixed-size patches, each of the patches may be linearly embedded, position embeddings may be added, and the resulting sequence of vectors may be fed into a transformer encoder. In certain aspects, the multi-azimuth fuser transformer may include self-attention mechanisms that may be configured to attend to the azimuth perspective angle of respective multi-azimuth LiDAR BEV features 342a, 342b to 342n when fusing features from the multi-azimuth LiDAR BEV features 342a, 342b to 342n into the fused BEV LIDAR feature volume 362. Furthermore, in certain aspects, the multi-azimuth fuser transformer is configured to take the BEV grid location as both query and key inputs, and optionally with view encoding to produce fused BEV features from all azimuth angles as the output values. The view encoding may be an encoded representation of the multiple azimuth perspective angles for each of the respective projections. The view encoding, while not necessary, guides the fusion of the multi-azimuth LiDAR BEV features 342a, 342b to 342n. When the view encoding is not utilized, the fusion may rely on feature matching between the multi-azimuth LiDAR BEV features 342a, 342b to 342n.

The multi-azimuth fuser transformer architecture may allow for effective information exchange between different azimuth viewpoints (e.g., with each sensor modality), enabling the integration of diverse information sources into a unified representation. In certain aspects, self-attention mechanisms may allow the multi-azimuth fuser transformer to selectively focus on relevant information while integrating features from multiple azimuth angles. In certain aspects, the self-attention mechanisms enables the model to weigh the importance of features at each grid location based on their relevance to the fusion process. In certain aspects that include multi-modal perception sensor data, the multi-azimuth fuser transformer shares parameters across both camera and LiDAR feature fusion processes. By sharing parameters, the model may effectively leverage commonalities between camera and LiDAR data, such as spatial relationships and object characteristics, to enhance fusion performance.

In certain aspects, the processing of image data follows a similar architecture to the multi-azimuth fusion process for point cloud data described herein, but includes some processes unique to handling image data. For image data, which is referred to herein as the second perception sensor data 304, the second perception sensor data 304 may be fed through a camera backbone 314. The camera backbone 314 may be an image encoder configured to extract features from the image data into one or more 2D feature maps. The one or more 2D feature maps may be sampled at multiple azimuth perspective angles to generate a plurality of projections.

At blocks 334a, 334b to 334n, each of which corresponds to one of the multiple azimuth perspective angles, the features that are viewed from the multiple azimuth perspective angles may be projected into 3D space (e.g., into 3D feature volumes). In certain aspects, the projection is guided by learned projections and optionally depth supervision, for example, obtained from LiDAR data or other depth data. For example, projection of features from the one or more 2D feature maps sampled from the one or more multiple azimuth perspective angles into 3D feature volumes may utilize a Lift-Splat approach, a deformable attention network (e.g., as implemented in BEVFormer), bilinear sampling, or other techniques. The one or more 2D feature maps may be infused with metric information such as depth information collected by a LiDAR system, a radar system or other depth perceiving sensor system. The infusion of metric information may enable depth supervision with respect to projecting features from the one or more 2D feature maps into the 3D feature volumes. The resulting 3D feature volumes are then collapsed onto the BEV plane, for example, using a differentiable BEV projection layer. In certain aspects, a differentiable BEV projection layer discretizes the 3D space into BEV cells and aggregates features from relevant 3D voxels. This BEV projection process may be repeated from multiple virtual camera viewpoints (azimuths) surrounding the vehicle at blocks 334a, 334b to 334n. Each viewpoint captures the scene from a different angle, resulting in multi-azimuth Camera BEV features 344a, 344b to 344n.

In certain aspects, the multi-azimuth Camera BEV features 344a, 344b to 344n are fused at block 354 into a fused BEV camera feature volume 364. The multi-azimuth Camera BEV features 344a, 344b to 344n may be fused into a fused BEV camera feature volume 364 by a multi-azimuth fuser transformer. In certain aspects, the multi-azimuth fuser transformer is configured to take the BEV grid location as both query and key inputs, and optionally with view encoding to produce fused BEV features from all azimuth angles as the output values. The view encoding may be an encoded representation of the multiple azimuth perspective angles for each of the respective projections. In certain aspects, the view encoding, while not necessary, guides the fusion of the multi-azimuth Camera BEV features 344a, 344b to 344n. In certain aspects, when the view encoding is not utilized, the fusion may rely on feature matching between the multi-azimuth Camera BEV features 344a, 344b to 344n.

In certain aspects that are not multi-modal, the resulting multi-azimuth LiDAR BEV features 342a, 342b to 342n or the multi-azimuth Camera BEV features 344a, 344b to 344n may be stored in the one or more memories of the apparatus, such as for use by self-driving vehicles or terrestrial robots performing tasks such as semantic occupancy prediction, semantic segmentation, 3D lane detection, 3D object detection or other tasks.

In certain aspects that are multi-modal, the resulting multi-azimuth LiDAR BEV features 342a, 342b to 342n, the multi-azimuth Camera BEV features 344a, 344b to 344n, and optionally other multi-azimuth modal feature set are combined, for example, through a further fusion process, to generate a multi-modal multi-azimuth feature map 370.

For example, once the fused multi-azimuth BEV features are obtained from each sensor modality, they may be concatenated together to create dense, multi-modal multi-azimuth BEV features. The concatenation process may preserve the spatial relationships and feature dimensions of the individual azimuth-specific features, ensuring that little or no information is lost during the fusion process. The fused multi-azimuth BEV features from cameras and LiDARs may be concatenated together to create dense, rich multi-modal multi-azimuth BEV features. These features may capture detailed information about object profiles, geometry, and/or semantics from multiple viewpoints and sensor modalities, such as facilitating robust perception in autonomous driving applications. The multiple viewpoints of the perception sensor data may enable a richer set of features to be extracted compared to traditional methods that utilize single viewpoints.

In certain aspects, the multi-modal multi-azimuth feature map 370 or the multi-azimuth LiDAR BEV features 342a, 342b to 342n or the multi-azimuth Camera BEV features 344a, 344b to 344n, for example in single modal aspects, may be utilized for one or more AD tasks, such as semantic occupancy prediction, semantic segmentation, 3D lane detection, 3D object detection or other tasks.

In certain aspects, a 3D semantic segmentation task performed by a vehicle or robot may integrate information from multiple azimuth viewpoints and/or sensor modalities, to gain a more comprehensive understanding of the scene. This may aid in accurately distinguishing between different semantic classes.

In certain aspects, a 3D object detection task may utilize the fusion of multi-azimuth, multi-sensor features to provide a more complete and/or detailed representation of objects in the scene. This may allow the model to accurately localize objects in 3D space and/or classify them into different categories.

In certain aspects, a 3D occupancy prediction task may utilize the fusion of features from multiple azimuth viewpoints and/or sensor modalities to enable the model to capture a holistic view of the environments occupancy status. This may facilitate accurate prediction of obstacles and/or free space in 3D space. In certain aspects, a 3D lane detection task may utilize the fusion of multi-azimuth, multi-sensor features to provide a more complete representation of lane markings and/or boundaries. This may enable the model to accurately detect lane markings and/or estimate lane geometry, such as even in challenging scenarios with varying road conditions or occlusions.

### Example Methods for Generating Multi-Modal Multi-Azimuth BEV

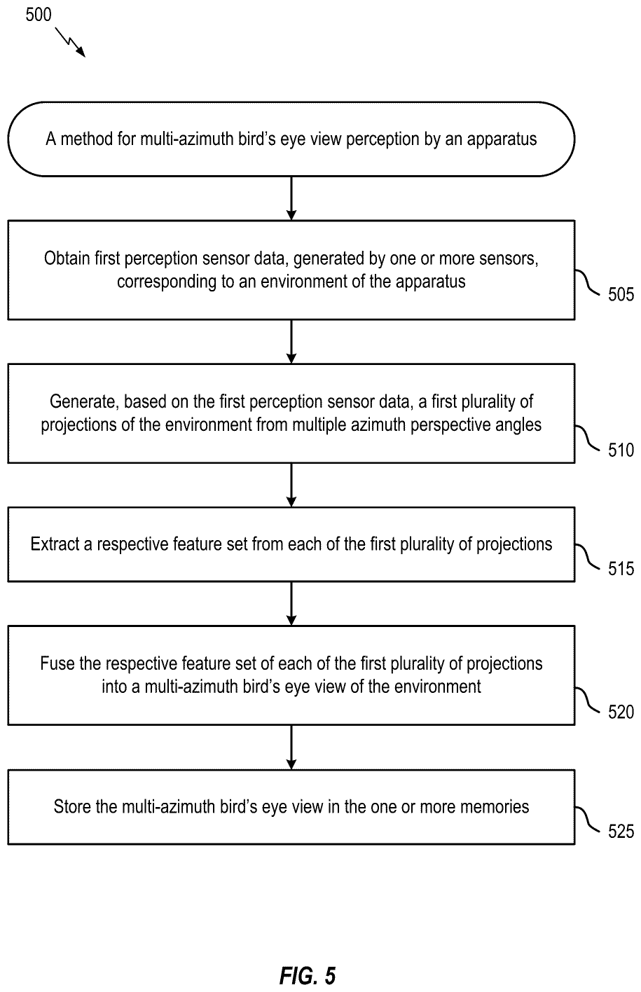

FIG. 5 shows a method 500 for bird's eye view perception by an apparatus, such as a vehicle 102 of FIG. 1 or other robotic device.

Method 500 begins at block 505 with obtaining first perception sensor data, generated by one or more sensors, corresponding to an environment of the apparatus. For example, block 505 may correspond to obtaining first perception sensor data 302 and/or second perception data 304 corresponding, for example, to image data, point cloud data or the like from one or more sensor systems discussed with reference to FIGS. 1-3.

Method 500 then proceeds to block 510 with generating, based on the first perception sensor data, a first plurality of projections of the environment from multiple azimuth perspective angles. For example, block 510 may correspond to blocks 332a, 332b to 332n and/or blocks 334a, 334b to 334n of the multi-azimuth fusion architecture 300 depicted and described with reference to FIG. 3.

Method 500 then proceeds to block 515 with extracting a respective feature set from each of the first plurality of projections. For example, block 515 may include utilizing the multi-azimuth LiDAR BEV features 342a, 342b to 342n and/or the multi-azimuth Camera BEV features 344a, 344b to 344n depicted and described with reference to FIG. 3 when extracting the respective feature set from each of the first plurality of projections. It is understood that the first plurality of projections may correspond to image data, point cloud data, or other modality of data although reference to the first plurality of projections discussed herein generally corresponds to point cloud data.

Method 500 then proceeds to block 520 with fusing the respective feature set of each of the first plurality of projections into a multi-azimuth bird's eye view of the environment. For example, block 520 may correspond to block 352 and/or block 354 of the multi-azimuth fusion architecture 300 depicted and described with reference to FIG. 3. Block 520 may include utilizing a multi-azimuth fuser transformer (also referred to as a multi-azimuth view fuser) to fuse the respective feature set of each of the first plurality of projections into a multi-azimuth bird's eye view of the environment.

Method 500 then proceeds to block 525 with storing the multi-azimuth bird's eye view in the one or more memories. The one or more memories may be and a non-transitory computer readable memory 244 of the apparatus 202 depicted and described with reference to FIG. 2 or another memory component separate from the apparatus 202.

In one aspect, method 500 further includes obtaining second perception sensor data, generated by the one or more sensors, corresponding to the environment of the apparatus, wherein the second perception sensor data comprises a different data modality than the first perception sensor data. In certain aspects, the second perception sensor data may be image data or point cloud data and the first perception sensor data may be point cloud data or image data, respectively. In certain aspects, the difference in data modality may correspond to the type of sensor collecting the data. For example, both the first perception sensor data and the second perception sensor data may generally be image data, but the first perception sensor data may be monocular viewpoint image data while the second perception sensor data may be stereo image data. Similarly, for point cloud data, the first perception sensor data may be point cloud data obtained with a LiDAR system and the second perception sensor data may be point cloud data obtained with a radar system.

In one aspect, method 500 further includes generating, based on the second perception sensor data, a second plurality of projections of the environment from a second set of multiple azimuth perspective angles. For example, the step of generating, based on the second perception sensor data, a second plurality of projections of the environment from a second set of multiple azimuth perspective angles may correspond to blocks 332a, 332b to 332n and/or blocks 334a, 334b to 334n of the multi-azimuth fusion architecture 300 depicted and described with reference to FIG. 3.

In one aspect, method 500 further includes extracting a respective second feature set from each of the second plurality of projections. For example, the step of extracting a respective second feature set from each of the second plurality of projections may include utilizing the multi-azimuth LiDAR BEV features 342a, 342b to 342n and/or the multi-azimuth Camera BEV features 344a, 344b to 344n depicted and described with reference to FIG. 3.

In one aspect, method 500 further includes fusing the respective second feature set of each of the second plurality of projections into a second multi-azimuth bird's eye view of the environment. For example, the step of fusing the respective second feature set of each of the second plurality of projections into a second multi-azimuth bird's eye view of the environment may correspond to block 352 or block 354 of the multi-azimuth fusion architecture 300 depicted and described with reference to FIG. 3. The step of fusing the respective second feature set of each of the second plurality of projections into a second multi-azimuth bird's eye view may include utilizing a multi-azimuth fuser transformer (also referred to as a multi-azimuth view fuser) to fuse the respective feature set of each of the first plurality of projections into a multi-azimuth bird's eye view of the environment.

In one aspect, method 500 further includes combining the multi-azimuth bird's eye view of the environment and the second multi-azimuth bird's eye view of the environment to generate a multi-modal multi-azimuth bird's eye view of the environment. For example, the step of combining the multi-azimuth bird's eye view of the environment and the second multi-azimuth bird's eye view of the environment to generate a multi-modal multi-azimuth bird's eye view of the environment may correspond to a fusion process whereby the fused BEV LiDAR feature volume 362 and the fused BEV camera feature volume 364 are combined to generate the multi-modal multi-azimuth feature map 370 depicted and described with reference to FIG. 3.

In one aspect, method 500 further includes storing the multi-modal multi-azimuth bird's eye view in the one or more memories. The one or more memories may be and a non-transitory computer readable memory 244 of the apparatus 202 depicted and described with reference to FIG. 2 or another memory component separate from the apparatus 202.

In one aspect, the first perception sensor data comprises at least one of image data or LiDAR data.

In one aspect, block 520 includes obtaining a respective view encoding for each of the first plurality of projections; and utilizing a multi-azimuth view fuser model configured to fuse the respective feature set of each of the first plurality of projections into the multi-azimuth bird's eye view of the environment based on the respective view encoding for each of the first plurality of projections.

In one aspect, each of the respective view encodings delineate an azimuth perspective angle of the multiple azimuth perspective angles.

In one aspect, method 500 further includes utilizing the multi-azimuth bird's eye view of the environment for at least one of a semantic occupancy prediction, a semantic segmentation, a lane detection, or an object detection.

In one aspect, the first plurality of projections of the environment comprise bird's eye view projections.

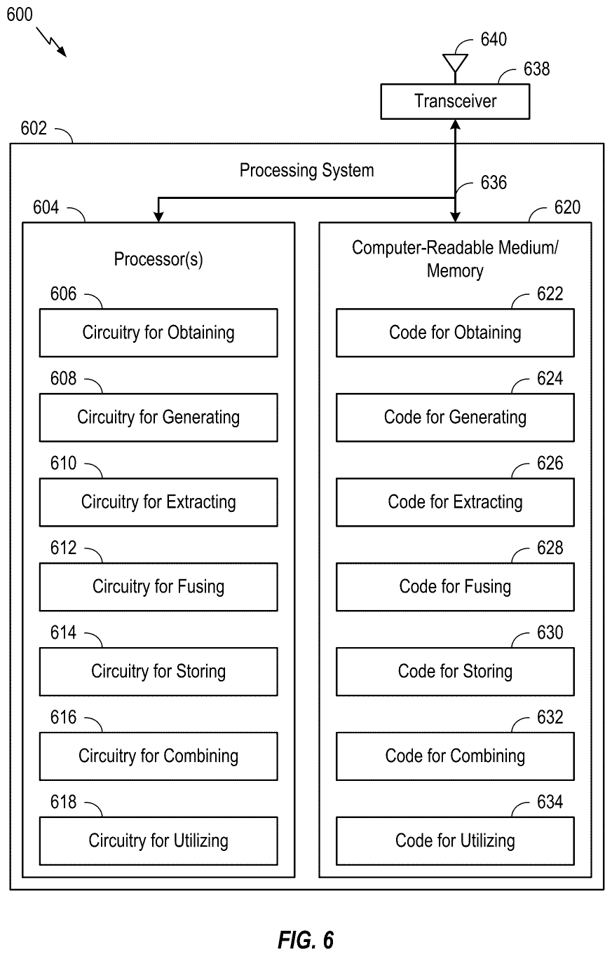

In one aspect, method 500, or any aspect related to it, may be performed by an apparatus, such as apparatus 600 of FIG. 6, which includes various components operable, configured, or adapted to perform the method 500. Apparatus 600 is described below in further detail.

Note that FIG. 5 is just one example of a method, and other methods including fewer, additional, or alternative operations are possible consistent with this disclosure.

### Example Apparatus

FIG. 6 depicts aspects of an example apparatus 600. In some aspects, apparatus 600 is a vehicle 102 of FIG. 1 or an apparatus 202 of FIG. 2, which may be a vehicle, robot, or other device.

The apparatus 600 includes a processing system 602 coupled to a transceiver 638 (e.g., a transmitter and/or a receiver). The transceiver 638 is configured to transmit and receive signals for the apparatus 600 via an antenna 640, such as the various signals as described herein. The processing system 602 may be configured to perform processing functions for the apparatus 600, including processing signals received and/or to be transmitted by the apparatus 600.

The processing system 602 includes one or more processors 604, which may be one or more processors 242 of apparatus 202 of FIG. 2. The one or more processors 604 are coupled to a computer-readable medium/memory 620 via a bus 636. In certain aspects, the computer-readable medium/memory 620 (e.g., non-transitory computer readable memory 244, also referred to herein as one or more memories of FIG. 2) is configured to store instructions (e.g., computer-executable code), including code 622-634, that when executed by the one or more processors 604, enable and cause the one or more processors 604 to perform the method 500 described with respect to FIG. 5, or any aspect related to it, including any operations described in relation to FIG. 5. Note that reference to a processor performing a function of apparatus 600 may include one or more processors performing that function of apparatus 600, such as in a distributed fashion.

In the depicted example, computer-readable medium/memory 620 stores code for obtaining 622, code for generating 624, code for extracting 626, code for fusing 628, code for storing 630, code for combining 632, and code for utilizing 634. Processing of the code 622-634 may enable and cause the apparatus 600 to perform the method 500 described with respect to FIG. 5, or any aspect related to it.

The one or more processors 604 include circuitry configured to implement (e.g., execute) the code (e.g., executable instructions) stored in the computer-readable medium/memory 620, including circuitry for obtaining 606, circuitry for generating 608, circuitry for extracting 610, circuitry for fusing 612, circuitry for storing 614, circuitry for combining 616, and circuitry for utilizing 618. Processing with circuitry 606-618 may enable and cause the apparatus 600 to perform the method 500 described with respect to FIG. 5, or any aspect related to it.

More generally, means for communicating, transmitting, sending or outputting for transmission may include the transceiver 638 and/or antenna 640 of the apparatus 600 in FIG. 6, and/or one or more processors 604 of the apparatus 600 in FIG. 6. Means for communicating, receiving or obtaining may include the transceiver 638 and/or antenna 640 of the apparatus 600 in FIG. 6, and/or one or more processors 604 of the apparatus 600 in FIG. 6.

### Example Clauses

Implementation examples are described in the following numbered clauses:
Clause 1: A method for multi-azimuth bird's eye view perception by an apparatus comprising: obtaining first perception sensor data, generated by one or more sensors, corresponding to an environment of the apparatus; generating, based on the first perception sensor data, a first plurality of projections of the environment from multiple azimuth perspective angles; extracting a respective feature set from each of the first plurality of projections; fusing the respective feature set of each of the first plurality of projections into a multi-azimuth bird's eye view of the environment; and storing the multi-azimuth bird's eye view in one or more memories.
Clause 2: The method of Clause 1, further comprising: obtaining second perception sensor data, generated by the one or more sensors, corresponding to the environment of the apparatus, wherein the second perception sensor data comprises a different data modality than the first perception sensor data; generating, based on the second perception sensor data, a second plurality of projections of the environment from a second set of multiple azimuth perspective angles; extracting a respective second feature set from each of the second plurality of projections; fusing the respective second feature set of each of the second plurality of projections into a second multi-azimuth bird's eye view of the environment; combining the multi-azimuth bird's eye view of the environment and the second multi-azimuth bird's eye view of the environment to generate a multi-modal multi-azimuth bird's eye view of the environment; and storing the multi-modal multi-azimuth bird's eye view in the one or more memories.
Clause 3: The method of any one of Clauses 1-2, wherein the first perception sensor data comprises at least one of image data or LiDAR data.
Clause 4: The method of any one of Clauses 1-3, wherein fusing the respective feature set of each of the first plurality of projections into the multi-azimuth bird's eye view of the environment comprises: obtaining a respective view encoding for each of the first plurality of projections; and utilizing a multi-azimuth view fuser model configured to fuse the respective feature set of each of the first plurality of projections into the multi-azimuth bird's eye view of the environment based on the respective view encoding for each of the first plurality of projections.
Clause 5: The method of Clause 4, wherein each of the respective view encodings delineate an azimuth perspective angle of the multiple azimuth perspective angles.
Clause 6: The method of any one of Clauses 1-5, further comprising utilizing the multi-azimuth bird's eye view of the environment for at least one of a semantic occupancy prediction, a semantic segmentation, a lane detection, or an object detection.
Clause 7: The method of any one of Clauses 1-6, wherein the first plurality of projections of the environment comprise bird's eye view projections.
Clause 8: One or more apparatuses, comprising: one or more memories comprising executable instructions; and one or more processors configured to execute the executable instructions and cause the one or more apparatuses to perform a method in accordance with any one of Clauses 1-7.
Clause 9: One or more apparatuses, comprising: one or more memories; and one or more processors, coupled to the one or more memories, configured to cause the one or more apparatuses to perform a method in accordance with any one of Clauses 1-7.
Clause 10: One or more apparatuses, comprising: one or more memories; and one or more processors, coupled to the one or more memories, configured to perform a method in accordance with any one of Clauses 1-7.
Clause 11: One or more apparatuses, comprising means for performing a method in accordance with any one of Clauses 1-7.
Clause 12: One or more non-transitory computer-readable media comprising executable instructions that, when executed by one or more processors of one or more apparatuses, cause the one or more apparatuses to perform a method in accordance with any one of Clauses 1-7.
Clause 13: One or more computer program products embodied on one or more computer-readable storage media comprising code for performing a method in accordance with any one of Clauses 1-7.
Clause 14: One or more vehicles, comprising: one or more sensors communicatively coupled to one or more memories and one or more processors; and the one or more processors, coupled to the one or more memories, configured to perform a method in accordance with any one of Clauses 1-7.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: one or more memories; and one or more processors, coupled to the one or more memories, and configured to cause the apparatus to:
obtain first perception sensor data, generated by one or more sensors, corresponding to an environment of the apparatus;
generate, based on the first perception sensor data, a first plurality of projections of the environment from multiple azimuth perspective angles;
extract a respective feature set from each of the first plurality of projections;
fuse the respective feature set of each of the first plurality of projections into a multi-azimuth bird's eye view of the environment; and
store the multi-azimuth bird's eye view in the one or more memories.

2. The apparatus of claim 1, wherein the one or more processors are configured to further cause the apparatus to:
obtain second perception sensor data, generated by the one or more sensors, corresponding to the environment of the apparatus, wherein the second perception sensor data comprises a different data modality than the first perception sensor data;
generate, based on the second perception sensor data, a second plurality of projections of the environment from a second set of multiple azimuth perspective angles;
extract a respective second feature set from each of the second plurality of projections;
fuse the respective second feature set of each of the second plurality of projections into a second multi-azimuth bird's eye view of the environment;
combine the multi-azimuth bird's eye view of the environment and the second multi-azimuth bird's eye view of the environment to generate a multi-modal multi-azimuth bird's eye view of the environment; and
store the multi-modal multi-azimuth bird's eye view in the one or more memories.

3. The apparatus of claim 1, wherein the first perception sensor data comprises at least one of image data or LiDAR data.

4. The apparatus of claim 1, wherein to fuse the respective feature set of each of the first plurality of projections into the multi-azimuth bird's eye view of the environment the one or more processors are configured to cause the apparatus to:
obtain a respective view encoding for each of the first plurality of projections; and
utilize a multi-azimuth view fuser model configured to fuse the respective feature set of each of the first plurality of projections into the multi-azimuth bird's eye view of the environment based on the respective view encoding for each of the first plurality of projections.

5. The apparatus of claim 4, wherein each of the respective view encodings delineate an azimuth perspective angle of the multiple azimuth perspective angles.

6. The apparatus of claim 1, wherein the one or more processors are configured to further cause the apparatus to utilize the multi-azimuth bird's eye view of the environment for at least one of a semantic occupancy prediction, a semantic segmentation, a lane detection, or an object detection.

7. The apparatus of claim 1, wherein the first plurality of projections of the environment comprise bird's eye view projections.

8. A method for multi-azimuth bird's eye view perception by an apparatus comprising:
obtaining first perception sensor data, generated by one or more sensors, corresponding to an environment of the apparatus;
generating, based on the first perception sensor data, a first plurality of projections of the environment from multiple azimuth perspective angles;
extracting a respective feature set from each of the first plurality of projections;
fusing the respective feature set of each of the first plurality of projections into a multi-azimuth bird's eye view of the environment; and
storing the multi-azimuth bird's eye view in one or more memories.

9. The method of claim 8, further comprising:
obtaining second perception sensor data, generated by the one or more sensors, corresponding to the environment of the apparatus, wherein the second perception sensor data comprises a different data modality than the first perception sensor data;
generating, based on the second perception sensor data, a second plurality of projections of the environment from a second set of multiple azimuth perspective angles;
extracting a respective second feature set from each of the second plurality of projections;
fusing the respective second feature set of each of the second plurality of projections into a second multi-azimuth bird's eye view of the environment;
combining the multi-azimuth bird's eye view of the environment and the second multi-azimuth bird's eye view of the environment to generate a multi-modal multi-azimuth bird's eye view of the environment; and
storing the multi-modal multi-azimuth bird's eye view in the one or more memories.

10. The method of claim 8, wherein the first perception sensor data comprises at least one of image data or LiDAR data.

11. The method of claim 8, wherein fusing the respective feature set of each of the first plurality of projections into the multi-azimuth bird's eye view of the environment comprises:
obtaining a respective view encoding for each of the first plurality of projections; and
utilizing a multi-azimuth view fuser model configured to fuse the respective feature set of each of the first plurality of projections into the multi-azimuth bird's eye view of the environment based on the respective view encoding for each of the first plurality of projections.

12. The method of claim 11, wherein each of the respective view encodings delineate an azimuth perspective angle of the multiple azimuth perspective angles.

13. The method of claim 8, further comprising utilizing the multi-azimuth bird's eye view of the environment for at least one of a semantic occupancy prediction, a semantic segmentation, a lane detection, or an object detection.

14. The method of claim 8, wherein the first plurality of projections of the environment comprise bird's eye view projections.

15. A vehicle, comprising: one or more sensors communicatively coupled to one or more memories and one or more processors; and the one or more processors, coupled to the one or more memories, and configured to cause the vehicle to:
obtain first perception sensor data, generated by the one or more sensors, corresponding to an environment of the vehicle;
generate, based on the first perception sensor data, a first plurality of projections of the environment from multiple azimuth perspective angles;
extract a respective feature set from each of the first plurality of projections;
fuse the respective feature set of each of the first plurality of projections into a multi-azimuth bird's eye view of the environment; and
store the multi-azimuth bird's eye view in the one or more memories.

16. The vehicle of claim 15, wherein the one or more processors are configured to further cause the vehicle to:
obtain second perception sensor data, generated by the one or more sensors, corresponding to the environment of the vehicle, wherein the second perception sensor data comprises a different data modality than the first perception sensor data;
generate, based on the second perception sensor data, a second plurality of projections of the environment from a second set of multiple azimuth perspective angles;
extract a respective second feature set from each of the second plurality of projections;
fuse the respective second feature set of each of the second plurality of projections into a second multi-azimuth bird's eye view of the environment;
combine the multi-azimuth bird's eye view of the environment and the second multi-azimuth bird's eye view of the environment to generate a multi-modal multi-azimuth bird's eye view of the environment; and
store the multi-modal multi-azimuth bird's eye view in the one or more memories.

17. The vehicle of claim 15, wherein the first perception sensor data comprises at least one of image data or LiDAR data.

18. The vehicle of claim 15, wherein to fuse the respective feature set of each of the first plurality of projections into the multi-azimuth bird's eye view of the environment the one or more processors are configured to cause the vehicle to:
obtain a respective view encoding for each of the first plurality of projections; and
utilize a multi-azimuth view fuser model configured to fuse the respective feature set of each of the first plurality of projections into the multi-azimuth bird's eye view of the environment based on the respective view encoding for each of the first plurality of projections.

19. The vehicle of claim 18, wherein each of the respective view encodings delineate an azimuth perspective angle of the multiple azimuth perspective angles.

20. The vehicle of claim 15, wherein the first plurality of projections of the environment comprise bird's eye view projections.
